(19) United States
(12) Patent Application Publication
(10) Pub. No.: US 2011/0055131 A1
(43) Pub. Date: Mar. 3, 2011

(54) METHOD OF UNIVERSAL COMPUTING DEVICE

(76) Inventor: Hung-Han Chen, Jacksonville, FL (US)

(21) Appl. No.: 12/554,081

(22) Filed: Sep. 4, 2009

Related U.S. Application Data
(60) Provisional application No. 61/238,049, filed on Aug. 28, 2009.

(51) Int. Cl. G06N 3/08

(52) U.S. Cl. 706/25

(57) ABSTRACT

A method for using artificial neural networks as a universal computing device to model the relationship between the training inputs and corresponding outputs and to solve all problems with estimation, classification, and ranking tasks in their nature. Raw data related to problems is obtained and a subset of that data is processed and distilled for application to this universal computing device. The training data includes inputs and their corresponding results, which values could be continuous, categorical, or binary. The goal of this universal computing device is to solve problems by the universal approximation property of artificial neural networks. In this invention, a practical solution is created to resolve the issues of local minima and generalization, which have been the obstacles to the use of artificial neural networks for decades. This universal computing device uses an efficient and effective search algorithm, Retreat and Turn, to escape local minima and approach the best solutions. Generalization for this universal computing device is achieved by monitoring its non-saturated hidden neurons as related its effective free parameters and In-line Cross Validation process. The output process of ranking is achieved by an added baseline probability retaining from best logistic regression model as a secondary order while the categorical results from a MLP neural network as the first order.

### CROSS-REFERENCE TO RELATED APPLICATIONS

This application claims the benefit of PPA, Ser. No. 61/238,049, filed 2009 AUG 28 by the present inventor, which is incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention relates to the use of artificial neural networks to model the relationship between the training inputs and corresponding outputs and to the validation of such model.

### BACKGROUND OF THE INVENTION

For past decades, the method of artificial neural networks, based upon the concept of artificial intelligence, has been one important branch of the scientific methods for problem solving. The supervised learning algorithm for artificial neural networks, Backpropagation, has made Multi-Layer Perceptrons (MLP) once popular for its ability to be used as an arbitrary function approximation mechanism, a.k.a. universal approximation property, as described in F. Scarselli, Ah Chung Tsoi, “Universal Approximation Using Feedforward Neural Networks: A Survey of Some Existing Methods, and Some New Results”, Neural Networks, vol. 11, no 1, pp. 15-37, 1998.

The MLP neural networks using Backpropagation learning algorithm constitute of many options of composing structures. We only show one form with one nonlinear hidden layer with sigmoid function and one linear output layer to be our example, as shown in FIG. 2. As listed in FIG. 10, equation (1) and (2), X(i) is ith input, Oₒ(j) is output for jth hidden neuron, and w(j,i) is the weight connects between ith input and jth hidden neuron. Also, Oₒ(n) is output for nth output neuron, and w(n,j) is the weight connects between jth hidden neuron and nth output neuron.

Backpropagation, as the prior-art described in D. E. Rumelhart, G. E. Hinton, and R. J. Williams, Learning internal representations by error propagation, in: D. E. Rumelhart and J. L. McClelland ed., Parallel Distributed Processing, Vol. 1, (The MIT Press, Cambridge, Mass., 1986), is a gradient descent method used with MLP neural networks. FIG. 10, equation (3) indicates that the weights are updated through gradients on error surface where Tᵢ is the learning factor. The error term E is measured in sum-squared of T(n)−Oₒ(n).

By using chain rule to propagate the error term E from output layer back to hidden layer, the gradients can be generalized with a delta function as in FIG. 10, equation (4). The delta function is then defined in FIG. 10, equation (5). The delta function can be calculated as in FIG. 10, equation (6) for output layer and FIG. 10, equation (7) for hidden layer accordingly. Backpropagation algorithm updates all weights of all neurons simultaneously based on gradients calculated from error function.

Unfortunately, there also have been some critics for MLP neural networks regarding different aspects from many intelligent researchers almost since the beginning. The most claimed disadvantage of MLP neural networks is that it may be trapped in local minima instead of finding the best results. Local minima are solutions that often seem to be the best with minimum error but in fact they are far from it. For one dimension, a minimum is when the gradient equal to zero. For multi-dimensions, the issue of minimization is much more complicated. In general, there are no bracketing methods available for the minimization of n-dimensional functions. All algorithms proceed from an initial guess using a search algorithm, which attempts to move in a downhill direction.

Another critic to prevent artificial neural networks from practical uses is that the MLP neural networks are claimed to have problems of dealing with complex problems. The concerns are: it is not integrated with cost function; it needs long time to train; it may be overfitting if training too long; it has catastrophic unlearning phenomenon; and it is mysticism to most people. To many neural network experts, most of these critics still are the challenges that artificial neural networks need to face today, especially those two described in the following paragraphs.

As for universal approximation property, discontinuity has been discovered for artificial neural networks. Tikk, D., Kóczy, L. T., Gedeon, T. D., 2003. A survey on the universal approximation and its limits in soft computing techniques. Int. J. of Approx. Reasoning, 33(2), pp. 185-202, discussed that the best approximation with bounded number of hidden units can not be achieved in a continuous way, i.e. the best approximation operator is not continuous. This has serious practical consequences: the stability of the computation cannot be guaranteed and training may be trapped in local minima.

In applications where the goal is to create a model that generalizes well for unseen data, the issue of overfitting becomes very important. In information theory, overfitting is when free parameters exceed the information content of the data and will lead to overspecified systems that fail to generalize beyond the fitting data. As in common practice, the number of weights in a MLP neural network is often treated as the number of free parameters. This assumption leads to a conclusion: large MLP networks will generalize poorly if their sizes exceed the necessary capacity.

The MLP neural networks with Backpropagation learning algorithm may have been claimed with some drawbacks, especially for the chances of being trapped at a local minimum; however, they do, in principal, offer all the potential of universal computing devices. They were intuitively appealing to many researchers because of their intrinsic nonlinearity, computational simplicity and resemblance to the behavior of neurons. Therefore, if the issues of local minima and overfitting can be resolved, we can see the unlimited potential MLP neural networks may have for the future advancement on machine learning and artificial intelligence.

There have been some fixes for artificial neural networks to address these disadvantages. However, most of these fixes work in specific scenarios and no obvious improvement from those fixes can be claimed to work for all situations and computational simplicity is often sacrificed.

On the issue of local minima, “It is both well known and obvious that hill climbing does not always work. The simplest way to fail is to get stuck on a local minimum.” is a quote from Minsky, M., Papert, S.: Epilog: the new connectionism. In: Perceptrons, 3rd ed., Cambridge: MIT Press, pp. 247-280 (1988). When people treat Backpropagation learning algorithm as a variation of hill climbing techniques, often they believe that Backpropagation may be trapped at local minima and fail to find the global minimum.

Interestingly, the proof of the local minima for XOR problem using a simple multilayer Perceptrons network has been disproved. Blum, E. K.: Approximation of Boolean Functions by Sigmoidal Networks Part I: XOR and Other Two-Variable Functions. Neural Computation, 1, 532-540 (1989) has proven there is a line of local minima on the error surface. However, other researchers have also proven either the points on Blum line are saddle points, as described in Hamey, L. G.: The Structure of Neural Network Error Surface. In: 6th Australian Conference on Neural Networks, pp. 197-200 (1995), or there is no local minimum on the XOR error surface, as described in Sprinkhuizen-Kuyper I. G., Boers, E. J.: A Comment on Paper of Blum: Blum's “local minima” are Saddle Points, Technical Report 94-34, Department of Computer Science, Leiden University (1994). According to them, Blum's proof is based on incorrect assumptions, and naive visualization of slices through error surface may fail to reveal the true nature of the error surface.

Also on the issue of local minima, there are some researches on the error surface of MLP neural networks. Kordos, M., Duch, W.: On Some Factors Influencing MLP Error Surface. In: 7th International Conference of Artificial Intelligence and Soft Computing, pp. 217-222 (2004), identify some important properties on the survey of factors influencing MLP error surface. They conclude that error surface depends on network structure, training data, transfer and error functions, but not on training methods. “Ravines” and “Troughs” on error surface are discussed both in Hush, D. R., Horne, B., Salas, J. M.: Error Surfaces for Multilayer Perceptrons. IEEE Transactions on Systems, Man, and Cybernetics, 22, 1152-1161 (1992) and in Kordos & Duch, (2004).

On the issue of preventing overfitting, there are many researches on finding the optimal structure of MLP neural network without excessive free parameter. A summary on those researches is given by Lawrence, S., Giles, C. L., &Tsoi, A. C. (1996). What Size Neural Network Gives Optimal Generalization? Convergence Properties of Backpropagation. In Technical Report UMIACS-TR-96-22 and CS-TR-3617, Institute for Advanced Computer Studies, Univ. of Maryland. This summary describes several theories for determining the optimal network size e.g. the NIC (Network Information Criterion), the generalized final prediction error (GPE), and the Vapnik-Chervonenkis (VC) dimension, a measure of the expressive power of a network. NIC relies on a single well-defined minimum to the fitting function and can be unreliable when there are several local minima. There is very little published computational experience of the NIC, or the GPE. Their evaluation is prohibitively expensive for large networks. VC bounds have been calculated for various network types. VC bounds are likely to be too conservative because they provide generalization guarantees simultaneously for any probability distribution and any training algorithm. The computation of VC bounds for practical networks is difficult.

Also on the issues of preventing overfitting and finding optimal structure, some studies have shown that larger networks appear to generalize as well as smaller networks, sometimes even better, published in Lawrence, S., Giles, L., Tsoi, A. C., Lessons in Neural Network Training: Overfitting May be harder than Expected, Proceedings of the Fourteenth National Conference on Artificial Intelligence, AAAI-97, AAAI Press, Menlo Park, Calif., 1997, pp. 540-545, and Caruana, R., Lawrence, S., Giles, L., Overfitting in Neural Nets: Backpropagation, Conjugate Gradient, and Early Stopping, Advance in Neural Information Processing Systems, Vol. 13, 2001, pp. 402-408. Their explanations, however, are intuitive and merely state their observations without further discussion on the effect of the MLP's free parameters.

Also on the issue of preventing overfitting, general techniques of cross-validation are often viewed as the most effective methods statistically. In prior art Kohavi, Ron, “A study of cross-validation and bootstrap for accuracy estimation and model selection”, Proceedings of the Fourteenth International Joint Conference on Artificial Intelligence 2 (12): 1137-1143. (1995), cross-validation is a technique for assessing how the result of a statistical analysis based on the sample data generalizes to an independent data set. One round of cross validation involves partitioning the sample data into complementary subsets, performing the analysis on one subset (called the training set), and validating the analysis with the other subset (called the validation set or testing set). To reduce variability, multiple rounds of cross validation are performed using different partitions, and the validation results are averaged over the rounds. There are several types of cross validation, e.g. repeated random sub-sampling validation, K-fold cross-validation, leave-one-out cross-validation. Cross-validation for multiple rounds is often time consuming and requires more manpower supervision.

On the issue of fast training, one of the remedies to this issue have been around by solving linear equations through the weights of hidden and output layers, Chen, H. H., Manry, M. T., Chandrasekaran, H., A Neural Network Training Algorithm Utilizing Multiple Sets of Linear Equations, Neurocomputing (25)1-3, 1999, pp. 55-72. Besides solving linear equations, there are similar optimization techniques like conjugate gradients and the Levenberg-Marquardt (LM) optimization. Masters T., Advanced Algorithms for Neural Networks: A C++ Sourcebook, NY: John Wiley and Sons (1995), has a good elementary discussion of conjugate gradient and Levenberg-Marquardt algorithms in the context of artificial neural networks. By doing so, however, the time and resource needed for such optimization will increase exponentially as the dimensions of matrix increase and this solution may limit the usage of large networks and possibly the data with large number of input features.

With its universal approximation property, MLP neural network applications solve problems by estimating or fitting the designed outputs. If desired outputs are in the form of continuous values, then the designed outputs are the same as the desired outputs. This is called Regression or Estimation. If desired outputs are in the form of binary or categorical values based upon a specific measurement, then the designed outputs are a transformation from this specific measurement regarding the number of classes. This is called Prediction, Identification, or Classification. These two types of outputs are normally seen in many applications for artificial neural networks.

On the issue of ranking, it makes possible to evaluate complex information according to certain criteria, often an estimation of their relevance. One method using neural networks for ranking, United States Patent Application 20090106223 ENTERPRISE RELEVANCY RANKING USING A NEURAL NETWORK, transform a subset of important input features into a relevancy score and then fit it with all input features and the weights of MLP neural networks. The relevancy score is always problem specific and different scores will be created if different subsets of input features are used. In statistics, however, ranking is a standard function in many theories and tools, e.g. logistic and linear regression.

The square of the sample correlation coefficient between the designed output and the input feature being used for prediction is useful information for the predictive power of an input feature. Consider using ith input feature Xᵢ to predict the designed output Oₒ, a linear model can be described as in FIG. 10, equation (8). Where, for the nth case, Oₒ is the response variable, Xᵢ is the regressor, and εᵢ is a zero mean error term. The quantities, β₀,β₁ are unknown coefficients, whose values are determined by least squares. The coefficient of determination, R-square, is a measure of the global fit of the model. Specifically, R-square is an element of [0, 1] and represents the proportion of variability in Oₒ that may be attributed to this regressor Xᵢ. By setting a threshold for R-square value, the training data can then be created with selected input features.

### SUMMARY OF THE INVENTION

The present invention is a practical method to implement universal computing device that can be used to solve many problems related to the tasks of estimation, classification, or ranking. This method not only generates solutions with the universal approximation property of artificial neural networks and also greatly reduces the probability of trapped in local minima with a new technology of search algorithm, Retreat and Turn, and prevents overfitting by monitoring the free parameters of MLP neural networks and In-line Cross Validation process.

The output process of ranking in the present invention is achieved by combining the categorical results from artificial neural network and a baseline probability calculated by the best model from auto search logistic regression. The ranking results from this universal computing device are first ordered with the categorical results and then ordered by the baseline probability within each class.

### BRIEF DESCRIPTION OF THE DRAWINGS

FIG. 1 is a block diagram illustrating an embodiment of the present invention.

FIG. 2 is a representation of a network structure used with an embodiment of the present invention.

FIG. 3 is a block diagram illustrating an embodiment of the present invention.

FIG. 4 is a block diagram illustrating an embodiment of the present invention.

FIG. 5 is a representation of a network structure used with an embodiment of the present invention.

FIG. 6 is a block diagram illustrating an embodiment of the present invention.

FIG. 7 is a representation of a data structure used with an embodiment of the present invention.

FIG. 8 is a block diagram illustrating an embodiment of the present invention.

FIG. 9 is a block diagram illustrating an embodiment of the present invention.

FIG. 10 is a set of equations used with an embodiment of the present invention.

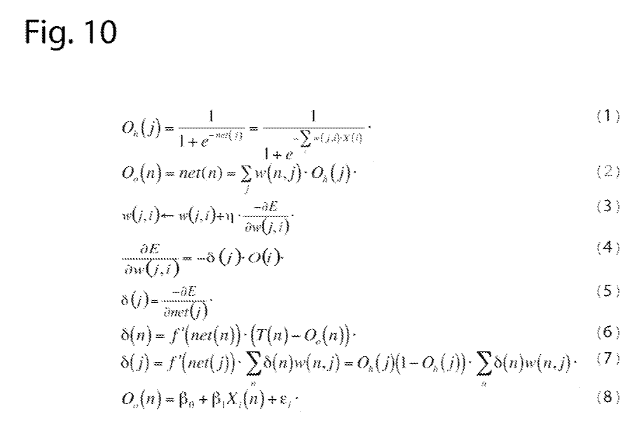

### DETAILED DESCRIPTION OF THE INVENTION

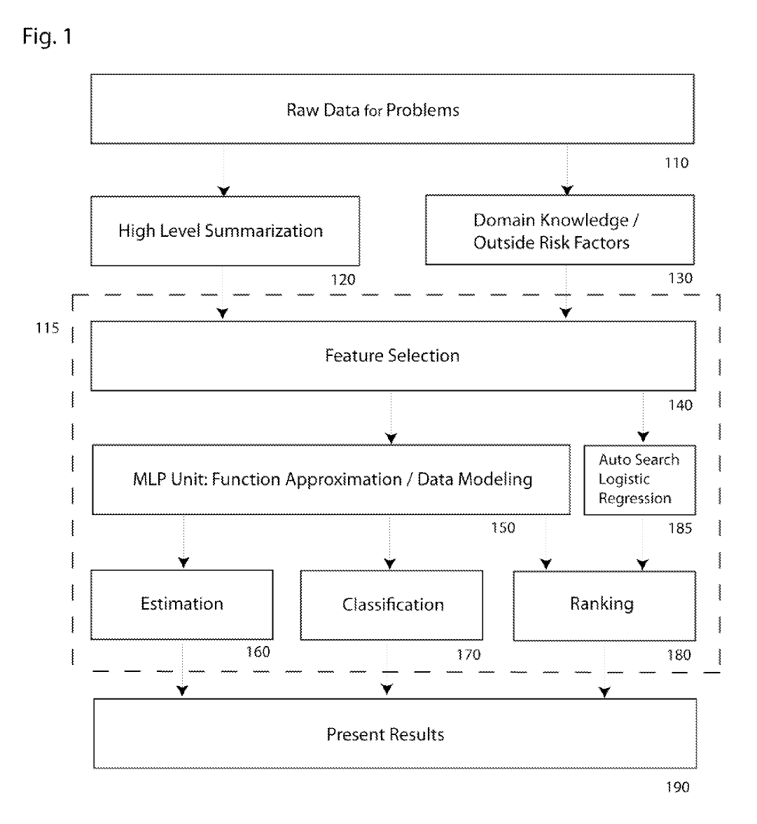

FIG. 1 illustrates, in block form, a method for implementing universal computing device to solve many problems with the tasks of estimation, classification, and ranking, according to the present invention. In block 110, raw data for problems is identified and obtained. The raw data is applied for high-level summarization, in block 120, to create basic features. In block 130, domain knowledge from experts or risk factors from other methods are possible to improve the quality of data with additional features. A set of processed data is then developed for applications with basic and additional features.

In more detail, still referring to the invention of FIG. 1, the raw data (block 110), the high-level summarization (block 120), risk factors, and the domain knowledge (block 130) are always problem specific. Once the processed data has been established with input features and corresponding desired outputs, this data is applied to a universal computing device in block 115 (containing blocks 140, 150, 160, 170, 180, and 185) to fit the unknown functions or to model the relationship between inputs and outputs.

In a preferred embodiment, the function of feature selection in block 140 takes action when there is a need to reduce the number of input features. The method for feature selection, included in the present invention, is achieved by setting a threshold to the R-square value. After the training data is created with selected input features in block 140, the MLP unit, block 150, then performs the tasks of function approximation and/or data modeling for the relationship between inputs and designed outputs. The results from MLP unit are processed in three ways, estimation (block 160), classification (block 170), and ranking (block 180). The final results from the universal computing device are presented in block 190.

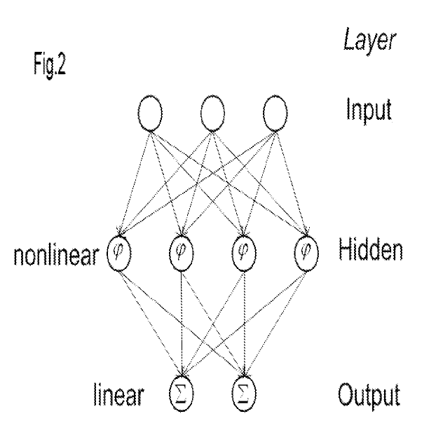

FIG. 2 illustrates a structure of prior-art artificial neural networks used with a preferred embodiment of the present invention. There could be many alternative structures for artificial neural networks. Nonlinear output neurons, two or more hidden layers, and different activation functions can be used with an embodiment of the present invention, as long as Backpropagation learning algorithm can be employed for those structures with multiple layers of neurons. Equations and structure for a MLP neural network are described in Background of the Invention section in detail.

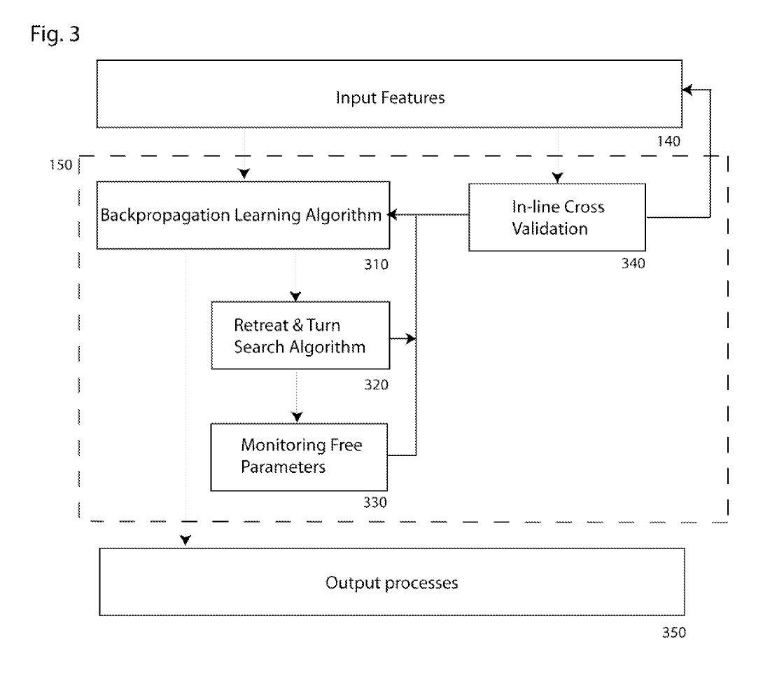

In more detail, now referring to the invention of FIG. 1 and FIG. 3, MLP unit (block 150) takes input features from training data from block 140 and send the results to output processes (block 160, 170, 180, represented by block 350 in FIG. 3). The functions of MLP unit, Backpropagation Learning, Retreat and Turn Search, Monitoring Free Parameters, and In-line Cross Validation, are described in block 150 (containing block 310, 320, 330, 340).

In block 310, Backpropagation learning algorithm functions is the foundation of the MLP unit, as well-known prior-art discussed in Background of the Invention. With Backpropagation, artificial neural networks potentially can be used as an arbitrary function approximation mechanism. Unfortunately, there exist several major issues for prior embodiments of Backpropagation preventing a practical implementation for MLP neural networks to become a universal computing device. One issue is that such a machine gets trapped in local minima, instead of finding global minimum for the error function E, defined in Background of the Invention. Another is the issue of generalization. Most experts believe the number of weights in a MLP neural network is the number of free parameters that are used to fit the relationship between inputs and corresponding outputs. And too many free parameters as they believe will overfit and cause the problem for generalization.

However, in the case of multidimensional minimization, if a machine gets trapped in local minima is more likely caused by the limitation of search choices than the possibility for the directional sum of gradients reaching a minimum on the error surface. As we know that only limited times Backpropagation can search on the error surface to descend, it is very possible that being trapped at a local minimum is simply because the search process hasn't found the right direction and distance to descend on the error surface. This misunderstanding can be confirmed by the proof and disproof of the local minima for XOR problem using a simple multilayer Perceptrons network, as described in Background of the Invention.

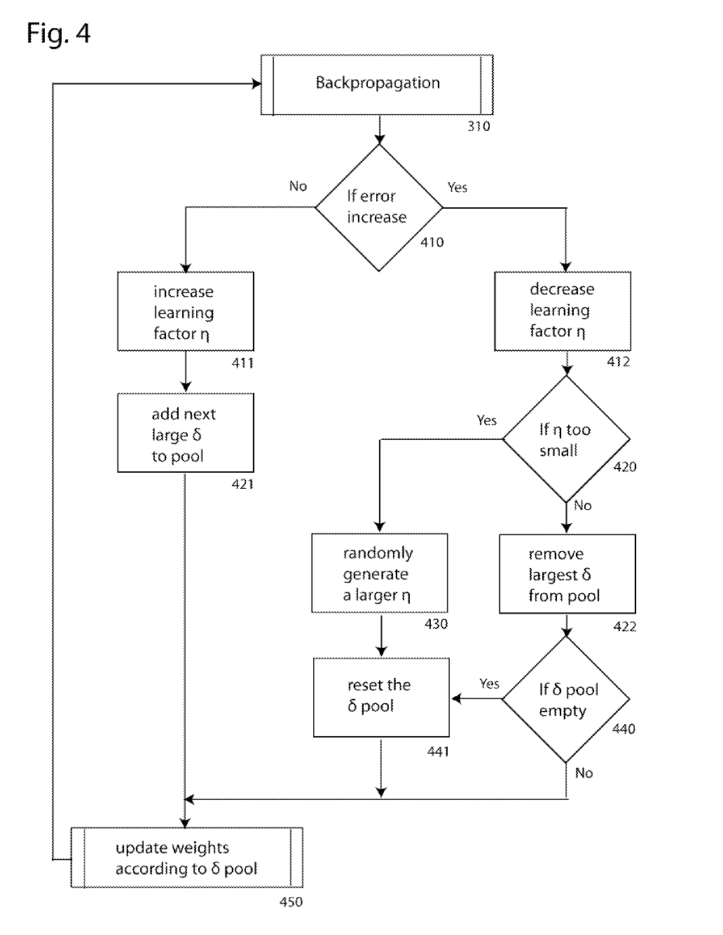

In more detail, now referring to the invention of FIG. 3 and FIG. 4, Retreat and Turn Search Algorithm in block 320 is the designate solution to escape local minima, published in Hung-Han Chen, “The Turning Points on MLP's Error Surface”, F. Sun et al. (Eds.) ISNN 2008, Part I, LNCS 5263, pp. 512-520, 2008. FIG. 4 illustrates the procedure of this search algorithm in detail. In the preferred embodiments, all hidden neurons are labeled with the position in the order of their δ(j) for each iteration and a δ pool is created to represent some of hidden neurons in such order, whose weights, along with all weights from output neurons, will be updated in Backpropagation (block 450). The size of this δ pool will be adaptive to the situation of error increase or decrease. Before Backpropagation updates hidden weights, if current error is less than the error from previous iteration (block 410), then it adds the hidden neuron (or neurons) with slightly larger delta function from outside to the δ pool (block 421) and increases the learning factor η (block 411).

More importantly, if error increases (block 410), then it recalls the best weights and decreases the learning factor η (Retreat, block 412). Then it removes the hidden neuron (or neurons) with largest delta function from the δ pool (block 422), which causes the direction from the sum of gradients to change as much as it can (Turn). If η becomes too small (block 420) which may not be able to tune the weights of MLP neural network for better solutions, it randomly generates a larger η (block 430). If δ pool becomes empty (block 440) which will leave all hidden neurons unchanged and handicap the learning capability of MLP neural networks, reset δ pool (block 441) to contain all hidden neurons, as described in FIG. 4.

This Retreat and Turn search process is an efficient and effective addition to Backpropagation (block 310) to escape local minima. It solves one of the major issues of Backpropagation without sacrificing its computational simplicity. It incorporates the firing status, as related to δ(j), of each hidden neurons to make a meaningful and efficient turn whenever it encounters an error increase. This method has been tested with many different types of data for up to 100,000 iterations without being stuck in a local minimum. In the meantime, this method updates the learning factor in its normal way often for tens of thousands iterations without the need to generate a random one. This means the path for descending on error surface is almost always smooth. Like water always flows to lower ground through “troughs” or “ravines”, the error can descend on the surface by turning away from the sidewalls (when encountering an error increase).

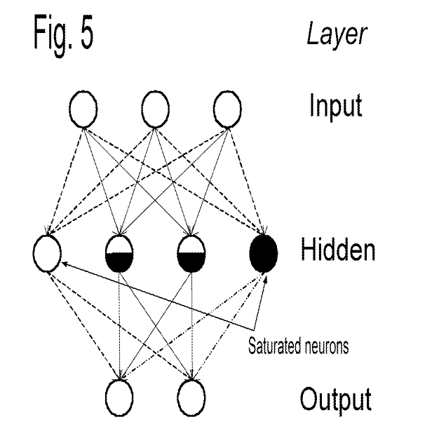

In more detail, now referring to the invention of FIG. 3 and FIG. 5, monitoring free parameters in block 330 is our first solution to prevent overfitting. Hung-Han Chen, “Monitoring MLP's Free Parameters for Generalization,” Proceedings of the 8th WSEAS International Conference on ARTIFICIAL INTELLIGENCE, KNOWLEDGE ENGINEERING and DATA BASES(AIKED'09), pp. 148-153, 2009, proves that the number of weights of a MLP neural network is not necessarily equal to its number of free parameters. For activation function of MLP neural networks, e.g. sigmoid function, there are two regions of saturation. One is near lower limit at 0. The other is near upper limit at 1. If the activation function of a hidden neuron operates at the part of near saturation for all training data, then we can declare them approaching the state of saturation at this moment of training (current iteration). Then the weights of this hidden neuron definitely have lost their status of being free parameters. FIG. 5 illustrates saturated and non-saturated hidden neurons for the MLP neural network. Assuming saturation regions are defined by predetermined thresholds, we can denote the empty circles as neurons operating at the saturation region of lower limit and the filled circles as neurons operating at the saturation region of upper limit. Half-filled circles are, of course, the neurons operating at the linear region.

It was further proved by Hung-Han Chen that the need to find the optimal size of MLP neural networks could be eliminated. The difference on numbers of free parameters between two MLP neural networks is not related to the difference of their sizes anymore. It does, however, relate to the difference on their numbers of non-saturated hidden neurons. Monitoring the number of non-saturated hidden neurons becomes important, as this number will eventually converge regardless its original size. Therefore the size of a MLP neural network is recommended to be as large as resource permits since larger networks converge to smaller errors faster. Then if the number of non-saturated hidden neurons converges to a fixed number, it is the best time to stop the training since it almost cannot be further improved.

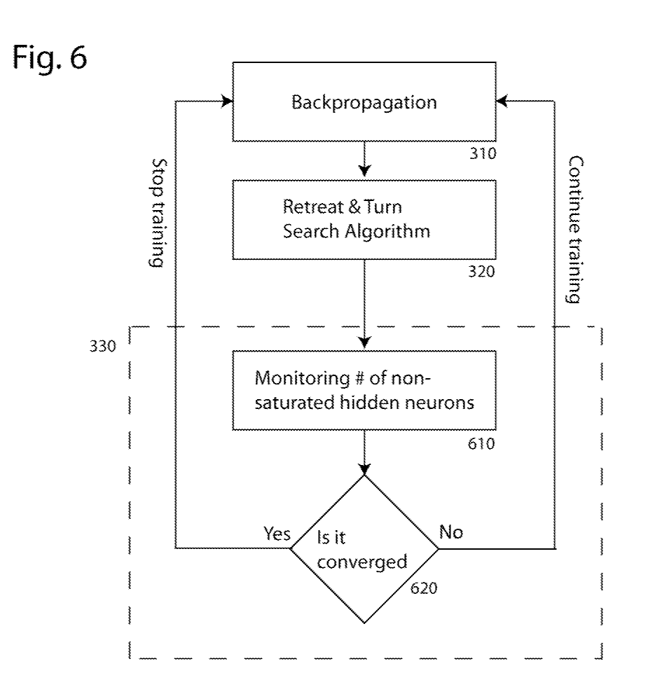

In more detail, now referring to the invention of FIG. 6, it illustrates the process to monitor the number of non-saturated hidden neurons (block 610) and stop the training if the number of non-saturated hidden neurons converges to a fixed number (block 620).

In more detail, now referring to the invention of FIG. 3, In-line Cross Validation in block 340 is our second solution to prevent overfitting and to reduce the time needed for training at the same time. As in the nature of artificial neural networks, the training result from each iteration represents a unique solution for the problem. On the course of training, the solution at certain iteration will be slightly better than the previous ones. The In-line Cross Validation technique (block 340) is especially designed for MLP neural networks, published in Hung-Han Chen, “Fast Training MLP networks with Lo-Shu Data Sampling,” Proceedings of the 8th WSEAS International Conference on ARTIFICIAL INTELLIGENCE, KNOWLEDGE ENGINEERING and DATA BASES (AIKED'09), pp. 165-169, 2009.

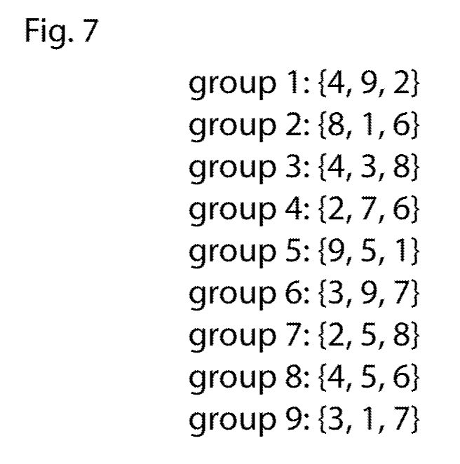

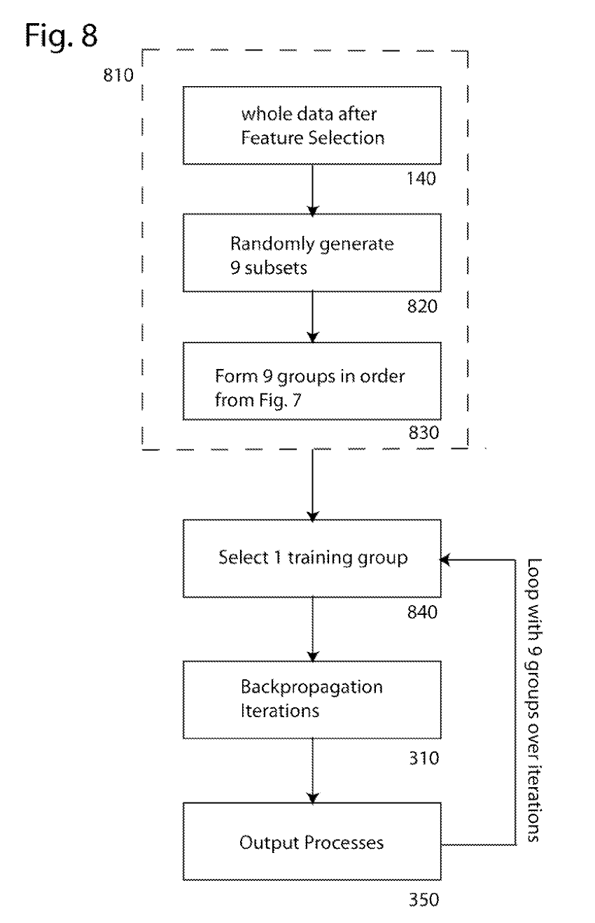

In further detail, now referring to the invention of FIG. 7 and FIG. 8, block 810 represents the process for automatically partitioning the whole data. Nine subsets are randomly generated in block 820. Nine predetermined groups, in FIG. 7, to include subsets for training are implemented in block 830. The MLP unit then trains one group instead of the whole data, block 840, and shift to the next group after a predetermined number of iterations. The first advantage with this technique is that less time is needed for training since only one third of whole training data are used when In-line Cross Validation is active. The time saving is about two third of the original time when all training data are used. The second advantage is that cross validation is performed when training has shifted from one group to the next group. For training groups from FIG. 7, average time for at least one subset to reappear for training is less than two shifts away, and at least two subsets to reappear for training is less than three shifts away. According to this arrangement, the course of training and validation can maintain a perfect balance as much as possible.

In further detail, now referring to the invention of FIG. 1, block 160, 170, and 180 represent the output processes of the universal computing device for the tasks of estimation, classification, and ranking, respectively. The output processes of Estimation (or regression, approximation) in block 160 and Classification (or prediction, identification) in block 170 are prior arts and normally seen in many applications for artificial neural networks. These output processes take the results from MLP unit (block 150) and transform them to desired format so that block 190 can present the results in the report.

In a preferred embodiment, Ranking (block 180) deals with those problems when an ordered list regarding to the probability of the target event is desired. An auto search logistic regression method (block 185), in addition to MLP's universal approximation property, is created to complete the function of ranking.

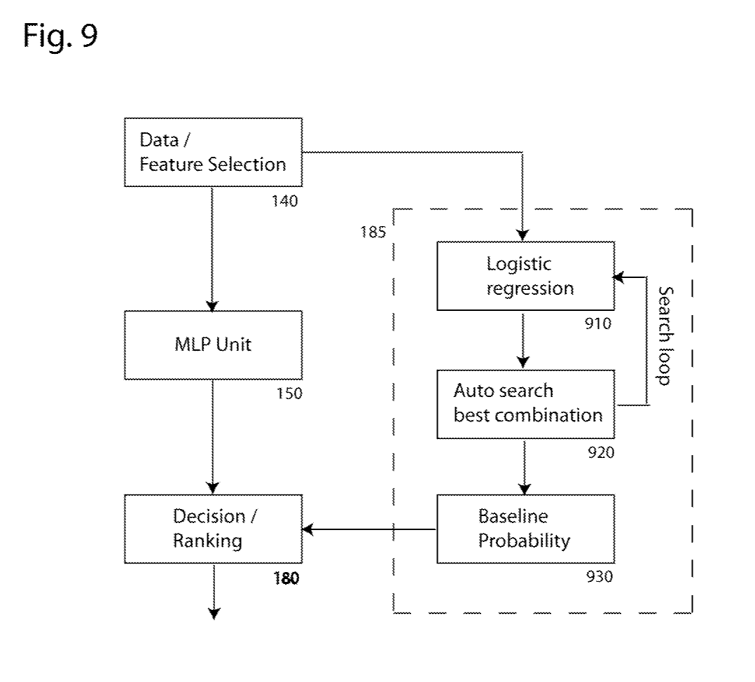

In further detail, now referring to the invention of FIG. 9, baseline probability (block 930) is obtained from the best logistic regression model (block 920), as the number of input features, ζ, chosen for logistic regression is predetermined and relatively small. As FIG. 9 illustrates, an automatic search loop will perform the calculation of logistic regression (block 910) for all the possible feature combinations (up to ζ input features). Since ζ is relatively small, a brute-force search is possible. One possible way to save time is to start searching with those input features that have higher values of R-square.

In further detail, now referring to the invention of FIG. 1 and FIG. 9, the ranking results (block 180) are first ordered with the categorical results (block 170) coming from MLP unit (block 150) and then ordered by the baseline probability (block 930) within each class.

The advantages of the present invention include, without limitation, the following.
1. The computing tasks of estimation, classification, and ranking can now be done easily.
2. It inherits universal approximation property from MLP neural networks.
3. It solves all problems the same way and makes no assumption when fitting the outputs from the inputs and adjustable weights.
4. The needed manpower is greatly reduced by many automatic processes.
5. Exploratory model can be built to explore the relationship between the inputs and outputs if only high-level summarization of raw data is used.
6. Risk factors and domain knowledge from experts can easily be added for additional input features.
7. The fear of the MLP trapped in local minima can be minimized, if not eliminated. Nevertheless, researchers have disproved the claimed local minima of XOR problem and multidimensional minimization is now known as a search problem.
8. Overfiting can be prevented by two methods.
9. By monitoring MLP's free parameters, there is no need to experiment on the optimal structure.
10. Cross validation can be performed in-line during training
11. It can improve the results from logistic regression on ranking problems.

In broad embodiment, the present invention is a method of universal computing device to solve many problems of estimation, classification, and ranking.

While the foregoing written description of the invention enables those skilled in the art to make and use what is considered presently to be the best mode thereof, those skilled in the art will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method of universal computing device for using artificial neural networks to solve all computing tasks of estimation, classification, and ranking, comprising:
processing raw data to obtain a trainable data set; and
modeling the relationship between inputs and corresponding outputs; and
processing the output results for estimation, classification, and ranking; and
presenting the final results.

2. The method of claim 1, wherein the step of processing raw data to obtain a trainable data set involves applying high-level summarization to raw data and/or obtaining risk factors and domain knowledge from experts.

3. The method of claim 1, wherein the step of processing raw data to obtain a trainable data set involves reducing the total number of input features, if there are too many, by only selecting those input feathers when their R-square values are greater than a certain threshold. The R-square is the square of the sample correlation coefficient between the target outputs and the input feature being used for prediction.

4. The method of claim 1, wherein the step of modeling the relationship between inputs and corresponding outputs involves applying data to a MLP neural network with Backpropagation learning algorithm to construct a solution by its universal approximation property.

5. The method of claim 4, further comprising the step of applying the Retreat and Turn Search Algorithm before updating the weights of hidden neurons. A δ pool is setup to label which hidden neurons and, for each iteration, the weights of hidden neurons included in this δ pool will be updated with it gradient.

6. The method of claim 4, further comprising the step of monitoring MLP's free parameters to decide whether hidden neurons are operating in non-saturated region or not. The need of finding an optimal structure for MLP neural networks can be eliminated while sizes of the MLP neural networks. Are not relevant to the number of free parameters. Only weights of non-saturated hidden neurons are effective free parameters. Stop the training when the number of non-saturated hidden neurons converges to a fix number.

7. A method of applying In-line Cross Validation to prevent overfitting when using artificial neural networks, comprising:
applying random sampling to a data set to construct predetermined number of subsets; and
applying predetermined method of grouping with those subsets to form another predetermined number of training groups; and
applying one group for MLP neural network training and shifting to another group after a predetermined number of iterations by a predetermined order.

8. A method of applying automatic search logistic regression to provide baseline probability when using artificial neural networks for ranking, comprising:
applying logistic regression to a data set with automatic search for all possible combination up to a predetermined number of input features; and
applying baseline probability retaining from best logistic regression model as a secondary order while the categorical results from a MLP neural network as first order.
